(19) United States
(12) Patent Application Publication
(10) Pub. No.: US 2007/0077944 A1
(43) Pub. Date: Apr. 5, 2007

(54) Method and system for providing a plurality of localized services information to a mobile device

(76) Inventors: Douglas M. Bellenger, Plymouth Meeting, PA (US); Charles N. Sacco, Thorofare, NJ (US); Nicole R. Radick, Philadelphia, PA (US); Matthew L. Pernberton, West Bend, WI (US)

Correspondence Address: REED SMITH LLP, 2500 ONE LIBERTY PLACE, 1650 MARKET STREET, PHILADELPHIA, PA, 19103, US

(21) Appl. No.: 11/542,388

(22) Filed: Oct. 3, 2006

Related U.S. Application Data
(60) Provisional application No. 60/724,329, filed on Oct. 5, 2005.

(51) Int. Cl. H04Q 7/20

(52) U.S. Cl. 455/456.1

(57) ABSTRACT

A system and method for providing localized information services to a user of a wireless device. The system and method include a locator that locates the wireless device, a service request receiver, wherein the service request requests a ranking of responsive services based on at least three factors, and wherein at least one of the at least three factors is the location returned by the locator, a user selectable interface presented to the wireless device, wherein the user is allowed to select at least one of the ranked responsive services via the user selectable interface, and a direction presentation, wherein the direction presentation includes geographic directions from the location returned by the locator to the selected at least one of the ranked responsive services. In an embodiment, the ranked services are restaurant services.

### CROSS REFERENCE TO RELATED APPLICATIONS

This application claims priority to U.S. Patent Application Ser. No. 60/724,329, entitled “A METHOD AND SYSTEM FOR PROVIDING A PLURALITY OF LOCALIZED SERVICES INFORMATION TO A MOBILE DEVICE”, filed Oct. 5, 2005, which application is hereby incorporated by reference herein as if set forth in the entirety:

### STATEMENT REGARDING FEDERALLY SPONSORED RESEARCH OR DEVELOPMENT

Not Applicable.

### BACKGROUND OF THE INVENTION

1. Field of the Invention

The present invention is directed generally to a method and system for wireless communications, and, more particularly, to a method and system for providing a plurality of localized services information to a mobile device.

2. Description of the Background

In 2003, mobile service in the United States was a $94 billion industry. It is estimated that there will be an annual increase of about 186 million cell phone users, bringing the total number of global users by 2007 to 2 billion. In 2004, wireless data represented $4 billion, or 4%, of the total wireless services market. This total value is projected to grow significantly in the coming years. By 2009, the global mobile data service industry is expected to total $189 billion. This wireless data industry includes text messaging, ring tones, games and entertainment content.

The standard wireless device now provides not only wireless calling, but also these wireless data and associated services, including wireless web, wireless headsets, and improved hardware, tools and applications. This improvement in service provision and hardware technology has allowed the wireless data network to become a central aspect of the global, internet-based economy. For example, in 2006 close to 2% of all online shopping will be done over an Internet enable wireless telephone.

The US restaurant industry is a $476 billion dollar industry with 900,000 selling units. This figure includes Full Service, Limited Service and Delivery/Carry Out restaurants. The restaurant industry has seen a 25.4% growth in business from 1999 to 2004. This increase is predicted to continue with expected annual growth of about 4.9%, thus making the restaurant industry account for about 4% of the US Gross Domestic Product.

With regard particularly to a “to-go” order, a great number of “hand offs” may occur. For example, when a call is received, a to go order often goes from a hostess (order), to a server (order implementation), to a cook (make product), to a server (deliver product to hostess), to a hostess (gives customer product), to the customer (gives credit card), to a server (runs card) and back to the customer. The process can take up to five minutes, and even with curbside pick up may be lengthy.

Mobile access to the Internet is, at present, principally using one of two platforms, namely BREW and Java 2 Mobile Edition. BREW connects users and allows instant messaging, photo and video sharing, multiplayer mobile games, smart navigation, and information, and is developer friendly. J2ME is used for PDAs, cell phones and other wireless devices. It allows users the ability to develop instant messaging applications, phone and video sharing, gaming, information and many other features.

In 2004, 45% of 24-35 year olds had used the Internet to gain more information about a restaurant. Sites are available to market, view menus, read reviews, and make reservations. Some delivery and carryout establishments offer ordering capabilities online. Numerous Internet ordering applications presently allow posting of menus online for customers to order from, pay and pick up or have delivered. Other sites may offer online reservations for eat-in customers. Such services may include gives order history, favorites, recommendations, distance, and a scheduler for repeat or future orders. Additionally, for example, certain restaurant guides may be available for download, but such information may quickly become “stale” if not regularly updated. Likewise, traditional methods of searching for establishments may suffer drawbacks in becoming stale, or having low quality of search results returned based on the costs associated with making a search, as illustrated in FIG. 1.

Thus, although there are currently methods to obtain information about restaurants via mobile services, none of the aforementioned methods enable a consumer to access multiple localized relevant service options and services through one access point in a mobile device via the wireless web. Hence, there exists a need for a service method and system that provides detailed restaurant information, including menus, directions, ratings, reservations and online ordering, using GPS-based or other location-specific technology, through a wireless mobile device.

### BRIEF SUMMARY OF THE INVENTION

The invention may include a system and method for providing localized information services to a user of a wireless device. The system and method may include a locator that locates the wireless device, a service request receiver, wherein the service request requests a ranking of responsive services based on at least three factors, and wherein at least one of the at least three factors is the location returned by the locator, a user selectable interface presented to the wireless device, wherein the user is allowed to select at least one of the ranked responsive services via the user selectable interface, and a direction presentation, wherein the direction presentation includes geographic directions from the location returned by the locator to the selected at least one of the ranked responsive services. In an embodiment, the ranked services are restaurant services.

The present invention solves problems experienced with the prior art by providing a service method and system that provides detailed restaurant information, including menus, directions, ratings, reservations and online ordering, using GPS-based or other location-specific technology, through a wireless mobile device. Those and other advantages and benefits of the present invention will become apparent from the detailed description of the invention herein below.

### BRIEF DESCRIPTION OF THE SEVERAL VIEWS OF THE DRAWING

FIG. 1 is a state diagram illustrating the states of a search;

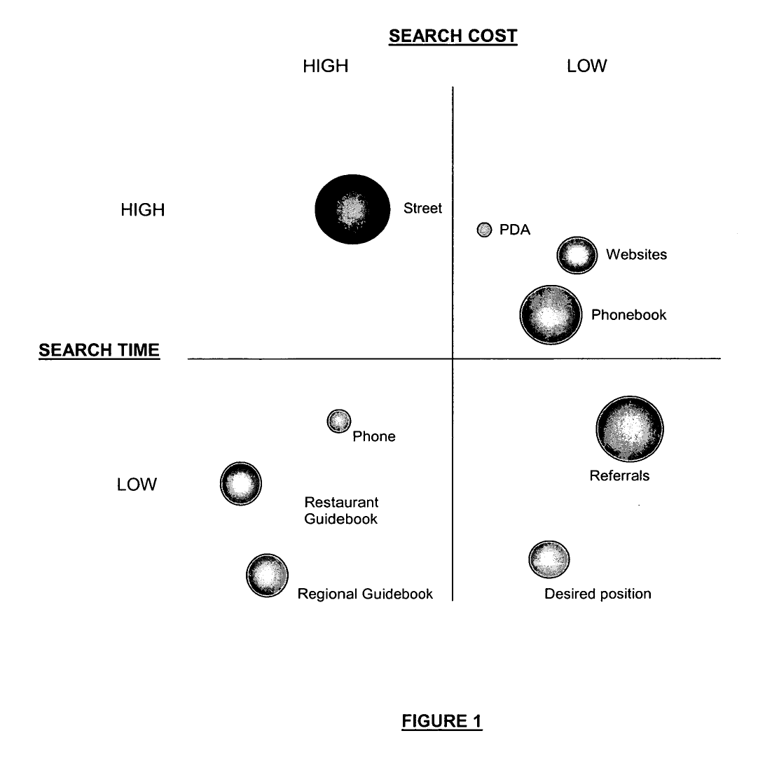

FIG. 2 is a block diagram illustrating an embodiment of the present invention;

FIG. 3 is a screen shot illustrating an embodiment of the present invention;

FIG. 4 is a flow diagram illustrating an embodiment of the present invention;

FIG. 5 is a block diagram illustrating an embodiment of the present invention; and

FIG. 6 is a screen shot illustrating an embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical mobile services applications. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention assists, for example, a traveler who lacks the time and/or knowledge to make decisions on dining options in an unfamiliar location. The typical traveler has a small amount of time to spend on decision-making and a small amount of knowledge about a location on which to base that decision. The traveler could be a business person or a vacationer, for example. As such, the present invention assists these travelers with decisions on where to eat their meals, where to entertain business partners, and what restaurants will keep their expenses in line with their budget. Similarly, parents of multiple children, or caretakers of multiple persons of any age may be so busy with care giving tasks so as to necessitate the use of the services of the present invention. Thus, the time-constraints on such care givers may be such that, although the care giver has knowledge of a particular geographic location, the care giver nonetheless does not have sufficient time to use that knowledge in order to obtain food for those to whom care is given. Likewise, younger persons, such as those between the ages of 18 and 25, may have knowledge of a geographic location, and time, but may not know opening and closing times of establishments, or available delivery hours, in the event of a need to obtain food at off-peak hours, and hence such persons may make use of the services of the present invention.

Use of the services provided in the present invention may be made available, for example, on a pay-per-use basis, or on a predetermined, such as monthly, fee schedule. Use made available may be, for example, unlimited usage, a certain usage level with spill-over charges, or a single query use only. Per transaction fees may be, for example, in the range of $0.25-$1.50, dependent upon the user or transaction type, and predetermined fees may be, for example, in the range of $1.00-$10.00 dependent upon similar factors. Similarly, the services may be made available initially for lower fees, or for no fee, in order to allow users to assess the services before paying additional amounts for the services.

Likewise, the present invention may be provided, based on user type, as a tiered service. For example, a first level may offer only the search and find capabilities. It may allow for the most basic transactions to be completed for users that do not find value in additional functions. Once the application is successfully downloaded onto the wireless phone/device, the consumer may be able to search for dining options based upon location. More limited search options may be made available, such as price level, food type and length of dining time. Based upon the search criteria selected, various dining options may be displayed. A second level may offer the first level's capabilities, along with additional reservation service. After searching, the consumer may have the option to make reservations at select venues. A third level may offer capabilities from the first two levels, along with the ability to purchase food for pick-up from participating restaurants.

Similarly, restaurants may be charged a fee for subscribing to the service. For example, restaurants may be charged a fixed annual fee negotiated with individual restaurants. Fees may be based upon expected increase in consumer traffic and corresponding increase in revenues as a result of this service, or by geographic location, for example. Restaurants may additionally be charged for access to market research gained through the use of the present invention, such as quality information and survey responses, and information about the customers who use the service, such as demographic information.

The present invention may offer, and charge for, access to services other than food providing services. For example, Movie tickets, Hotel reservations, Weather, Concert tickets/entertainment, and the like may be offered, in addition to the offering of restaurant information, based on the understanding of geographic location and user preferences gained through the use of the present invention.

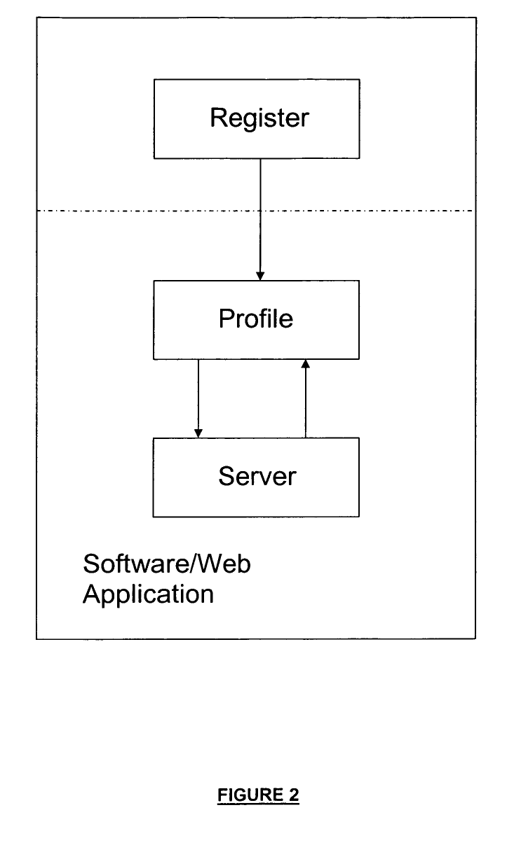

The present invention seamlessly connects end consumers of food and food suppliers, and particularly restaurants, via a mobile or wireless medium, as illustrated in FIG. 2. The present invention may provide improved revenue for food suppliers, due in part to the ease of use and access by consumers to the food suppliers, due in part to improvements in return business provided, and due in part to the marketing opportunities afforded. The present invention provides improved convenience and efficiency to consumers.

Referring now specifically to FIG. 2, there is shown a block diagram describing, generally, the functionality of the present invention. After registering with a wireless carrier, a user may be instructed to insert personal information into a profile in order to register for the services of the present invention. The user may insert the information either through a website or through the user interface of the mobile device. Through registering for the services offered by the present invention, users will have access to restaurant vendors that have also registered with the present invention. The profile the user creates may allow the software/web application to customize and direct specific restaurant information to the user based on the user's preferences.

Food suppliers, or suppliers of targeted goods or services that make use of the aspects of the present invention, may be compartmentalized, such as for responsiveness to user searches, using any of a variety of methods known to those skilled in the art, such as geographical presence, dining experience differences, industry growth, investment strategies, marketing strategies (i.e. target demographics), dining trends (e.g. healthy foods), foodservice types (takeout, delivery, full service), market segments (e.g. Italian, Mexican, family), and chains and franchises. Responses may be rank-ordered based on ratings within the desired compartmentalization.

Wireless services may preferably be used to transfer the data associated with the present invention. As such, the present invention will increase wireless usage, and will create additional revenue for wireless companies while also necessitating additional bandwidth. The services provided in the present invention may, in fact, be offered by the wireless provider, or by a third party vendor operating in association with a wireless provider. Further, such communications are preferably secure using methodologies known to those skilled in the art.

The present invention may thus include a single access point to access information from a variety of sources, which may be in part based on a current geographic location of the user. The access point may be a branded service available to dining establishments, such as part of the advertising of those food suppliers. Through the access point, users may have access to menus, ordering, directions, pricing, ratings, referrals, user groups, reviews, comparisons, and the like.

Options returned through the use of the present invention may be pushed to a user, or pulled by a user, based on a traditional search or a mobile search, and may be based on the current geography of the user, as well as other factors, such as ambiance, food type, quality, service speed, price, healthiness, flexibility (such as for last minute reservations), or comprehensive listings, for example. Factors may be weighted, such as factors available in one or more relational databases, based on, for example, user preferences entered in a query, or assessed preferences of that use based on tracked prior purchases, or assessed preferences of multiple users in that geographic area based on tracked prior purchases of those multiple users.

Thereby, the present invention may provide, for example, a searchable wireless web application that allows consumers to search, or have search results pushed for, restaurants, menus, reservations, and ordering from geographically assessed restaurants. Further, search results may include GPS-generated directions, unique to each user, to the eating establishment, based on the search results. The present invention may provide ease-of-use, and access using multiple mobile methodologies, such as mobile phone and PDA, that include GPS or triangulation for location determination.

The present invention, in order to provide search result information, may include the maintenance of one or more databases, such as Oracle or SQL databases, and/or may access information directly from, for example, web sites or databases maintained by participant food suppliers. Similarly, the present invention may include an automated information obtainer, whereby the automated information obtainer seeks out information for placement into searchable databases. For example, geographic information may be interrelated by customer, category, zip code, or latitude and longitude points.

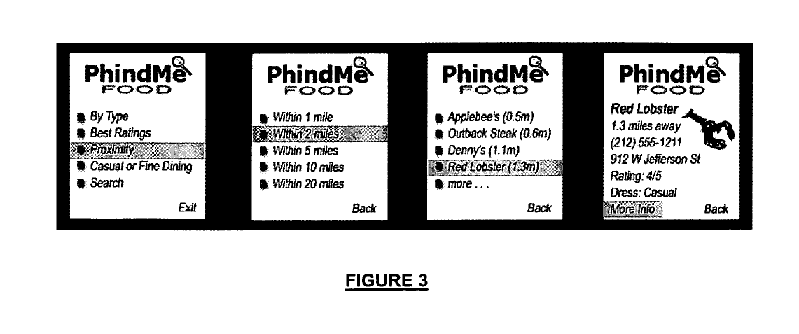

The present invention may provide ease of use to the traveler on the go. As such, the user interface (UI) may have minimal clicks or commands to navigate and return results, such as a one-click approach using either a numbered list, stylist for PDA phones, or arrow keys. Such an embodiment is illustrated in FIG. 3. Customers may thus get a restaurant listing without typing in any text. Voice activation may also be included. Server side applications may execute user requests from the cell phone, including xml outputs, Mapquest, Google Maps API, or Tele Atlas requests, and interfaces to restaurant ordering systems, and may include one or more “universal translators” to allow varying operating systems to connect and seamlessly execute requests.

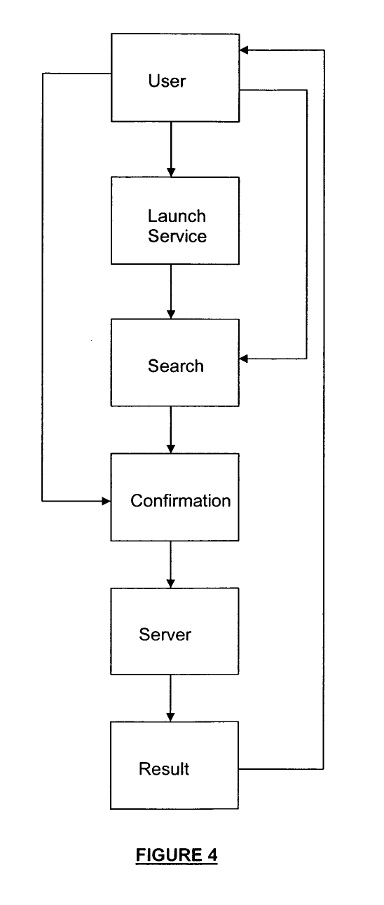

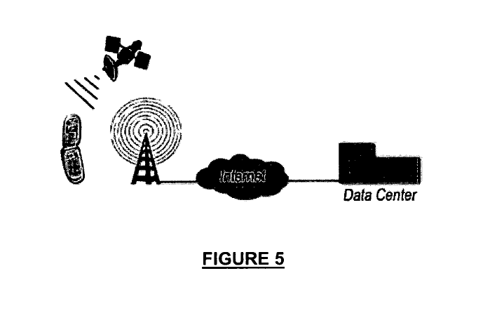

In a typical embodiment of the method associated with the present invention, as illustrated in the flow diagram of FIG. 4 and the embodiment of FIG. 5, a customer launches the service on a phone, the customer selects a search for restaurants, such as by Range, miles from current location, ratings, referrals, Zip Code, or area Code, the customer selects restaurant category (Seafood, Chinese, Chains, etc.), a notification window appears to let the user know the service uses the Internet and charges may apply for usage, and the customer accepts. Information may then be sent via the Internet to servers in a data center, and such information may include Longitude and Latitude coordinates (deg:min:sec), Range (1, 2, 5, 10, 15, 20, 25 miles), Zip code (null value sent if not selected), Area Code (null value sent if not selected), Food Category, or other HTML information required to communicate with phone. The server side computer retrieves listing from database and returns a list of restaurant names in standards for character transition formats, such as, for example, XML format, back to the phone. After the customer selects a restaurant, another request is made of the server and the following information may be returned: Restaurant name, Rating, Phone Number, Address, or Distance from current location. The customer may then receive specific directions, based on current customer location assessed based on a locating of the mobile phone, ordering information, and menus.

Additionally, a provider of services of the present invention may, separately from embodiments discussed hereinabove, provide an interactive interface, accessible, for example, via the Internet, whereat users can register and enter preferences, set up accounts, and make payments, and whereat restauranteurs can enter information for use in the services of the present invention, make payments, place advertisements, and/or access recommended templates for the desired formatting of the presentation of restaurant-related information to a user. Further, such interfacing of food suppliers with the Internet site may be performed through vendors, customer service persons, or the like.

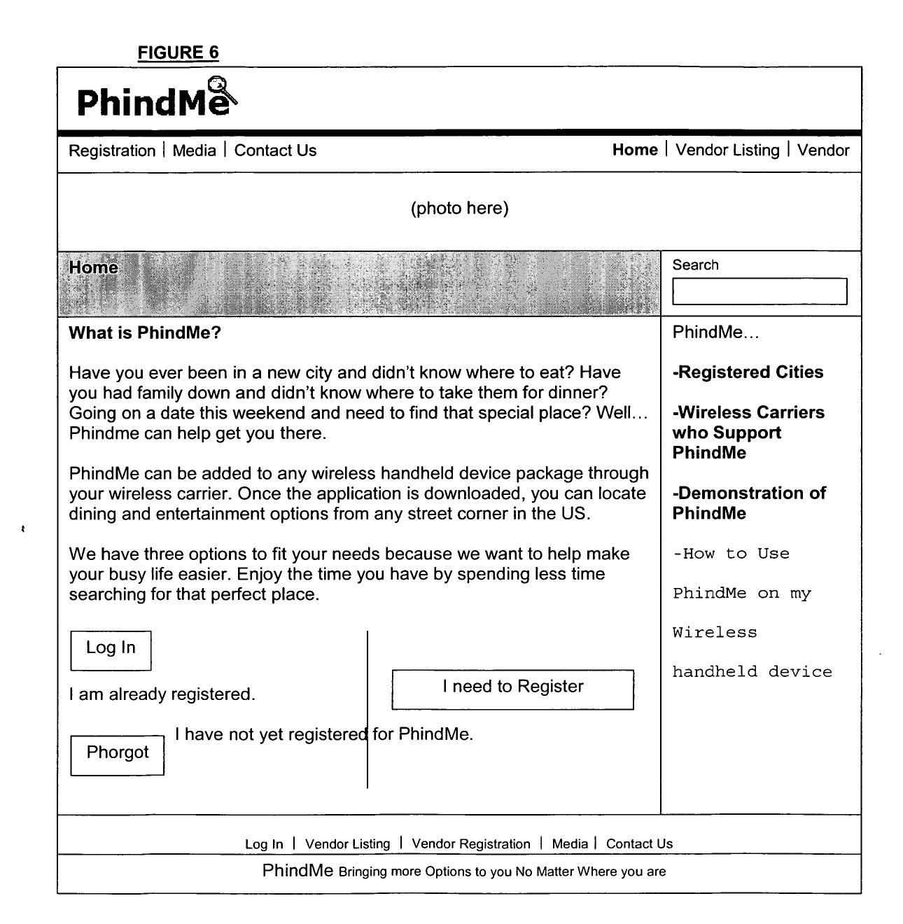

An exemplary Internet access page is illustrated in FIG. 6. The toolbar may contain Home, Vendor Listing, Vendor Registration, Media and Contact Us. The search area may allow a user to search for a particular interest. The side bar may also show additional reference items including View Registered Cities, View Wireless Carriers who support the present invention and How to use on a wireless handheld device. The user may Log In on the left side including a text box for username and password. The right side may have an “I need to Register” button that may take the user to a form page with a number of required fields for the user to complete and then submit. The first time the user logs in he may need to enter information into a profile including home address, cell phone number, email address, wireless carrier name, top three cities of interest/most visited, age and up to three account numbers. Account numbers will be securely stored for purchasing. The user also may have the option to sign up for a newsletter to go to the email address based on their profile.

Once a vendor registers on the site, he may be listed on the site as a registered vendor. He may have the option to post an official web address. The page may consist of a search area for location, cuisine type and price range, which will list those venues that meet the requirements of a search. The vendor may enter the venue contact information, address, phone number, web address, cuisine type based on the available check boxes and price range.

Via the Internet site and information generated based upon usage of the services, the present invention may track a particular user's food likes and dislikes, such as in order to customize and direct specific advertising to that user. Consumers may be able to connect to the service to see past restaurants and dishes that the user has liked, and the user may rate and comment on those dishes to provide other consumers information about each restaurant and service.

Feedback regarding the Internet site itself and the services provided by the present invention may be entered via the Internet site. As such, the Internet site may allow for the use of the present invention in different demonstration modes. For example, restaurants may create new features for testing, request new features for testing, or provide results gained in testing. Consumers may access and fill out surveys. Discounted rates for restaurants, consumers, or free food items may further stimulate the use of the present invention. Repeat usage or returning annual or monthly customers may likewise receive usage or loyalty bonuses or food-related promotions. Rewards may change based on location, or may be random within certain locations on certain days, for example. Similarly, gift cards may be available to many restaurants for users of the present invention.

The services of the present invention may be promoted via conventional methods, as well as via the Internet site. For example, the services may be advertised in restaurants, including server promotions and on tables in restaurants, on restaurant web sites, at restaurant and food related conferences, through sales associates, and on television, in print, and on radio. Print advertising may include, for example, magazines, newspaper, collegiate newspapers, taxi signs, bus signs, transportation hub signs, and billboards.

In an embodiment of the present invention, the services described above maybe provided to vendors via an agreement, such as a license agreement, whereby the various vendors and aspects of the present invention maybe inter-related between disparate parties. By way of non-limiting example only, two vendor licensees may each offer differing, but related, services. In this case, the present invention may identify the elements of each license and filter the licensees into various service offerings and/or provide each licensee the opportunity to sign and/or further augment their license agreements. In each case, the present invention may additionally act as a license broker wherein certain licensees are further brought together with third parties, who may be non-licensees, licensees, vendors, or prospective vendors.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. A system for providing localized information services to a user of a wireless device, comprising:
a locator that locates the wireless device;
a service request receiver, wherein the service request requests a ranking of responsive services based on at least three factors, and wherein at least one of the at least three factors is the location returned by said locator;
a user selectable interface presented to the wireless device, wherein the user is allowed to select at least one of the ranked responsive services via said user selectable interface; and
a direction presentation, wherein the direction presentation includes geographic directions from the location returned by said locator to the selected at least one of the ranked responsive services.

2. The system of claim 1, wherein said locator comprises a GPS locator

3. The system of claim 1, wherein said locator is a triangulating locator.

4. The system of claim 1, wherein the at least three factors comprise ones selected from the group consisting of the location, service ratings, survey responses, and service geographic range.

5. The system of claim 4, wherein the ranked services comprise restaurant services.

6. The system of claim 1, wherein the wireless device comprises a PDA.

7. The system of claim 1, wherein the wireless device comprises a cellular phone.
